(19) United States
(12) Patent Application Publication
(10) Pub. No.: US 2026/0366613 A1
(43) Pub. Date: Nov. 19, 2026

(54) PLANETARY GEAR UNIT WITH PLANET CARRIER AND RING GEAR

(71) Applicant: SEW-EURODRIVE GMBH & CO. KG, Bruchsal (DE)

(72) Inventors: Markus WÖPPERMANN, Karlsbad (DE); Ermalt LAMAJ, Heddesheim (DE); Max Alexander DENKHAUS, Leimen (DE)

(73) Assignee: SEW-EURODRIVE GMBH & CO. KG, Bruchsal (DE)

(21) Appl. No.: 19/132,438

(22) PCT Filed: Oct. 24, 2023
(86) PCT No.: PCT/EP2023/079645

§ 371 Date: May 23, 2025

(30) Foreign Application Priority Data
Nov. 24, 2022 (DE) 102022004397.1

(51) Int. Cl. F16H 57/08; F16H 1/28; F16H 57/02

(52) U.S. Cl. CPC F16H 57/082; F16H 1/28; F16H 57/02; F16H 2057/085

(57) ABSTRACT

A planetary gear unit includes a planet carrier and a ring gear. The planet carrier has a first cheek, a second cheek, and web regions. The first cheek is connected to the second cheek via the web regions, and the first cheek has a slope on its inner surface. A securing ring is received in the first cheek and is arranged axially between the slope and the web regions.

### FIELD OF THE INVENTION

The present invention relates to a planetary gear unit with planet carrier and ring gear.

### BACKGROUND INFORMATION

In certain conventional systems, a planetary gear stage has a planet carrier and a ring gear.

A planetary gear unit in which a shaft nut is screwed onto the output shaft of the planetary gear unit is described in U.S.

Patent Application Publication No. 2004/0235609. The bearing of an input shaft is received in the planet carrier of the planetary gear unit.

A bearing arrangement for a planetary gear unit is described in German Patent Document No. 10 2020 007 324.

A planetary gear unit is described in U.S. Patent Application Publication No. 2007/0078037.

A planetary gear unit is described in Chinese Patent Document No. 115013484.

A planetary gear unit is described in Chinese Patent Document No. 113531060.

### SUMMARY

Example embodiments of the present invention provide a compact planetary gear unit, e.g., with the greatest possible power per installation volume.

According to example embodiments, a planetary gear unit is provided with a planet carrier and ring gear. The planet carrier has a first cheek, a second cheek, and web regions, and the first cheek is connected to the second cheek via the web regions. The first cheek has a slope on its inner surface, and a securing ring is received in the first cheek and is arranged axially between the slope and the web regions.

An advantage of this is that, due to the slope, the securing ring can be positioned in a range of great wall thickness in the first cheek. A shaft nut for adjusting the bearing tension can be arranged in the region of thinner wall thickness following the slope. The radial wall thickness of the first cheek axially before the slope is thus thinner than the radial wall thickness of the first cheek behind the slope. Due to the slope, more installation space is available for an input planet carrier shaft of an input stage of the gear unit if the planet carrier shaft protrudes into the first cheek, and this planet carrier shaft is connected for conjoint rotation with that planetary gear sun gear which is in mesh with planet gears arranged rotatably mounted in the planet carrier.

The slope thus provides increased stability under shear loads.

The securing ring arranged in the more massive region of the first cheek axially limits those bolts that protrude through a respective through bore of the first cheek. Opposite the axial direction, the bolts are limited by insertion into a blind bore in the second cheek. The force diversion of the axial limitation thus takes place through the more massive region of the first cheek.

Overall, the arrangement described herein results in a robust configuration with low material usage and thus the gear unit can be subjected to high power with a small installation volume.

For example, the bearings of the planet carrier and the bearings of an input shaft of the planetary gear unit are at a distance from the slope, e.g., at an axial distance. Thus, none of the bearings rest against the slope.

According to example embodiments, bolts of the planetary gear unit are at least partially plugged into blind bores in the second cheek, and the bolts protrude through bores passing through the first cheek. An advantage of this is that the bolts are axially limited on one side by the blind bore.

According to example embodiments, the securing ring axially limits the bolt or bolts of the planetary gear unit. An advantage of this is that the securing ring is supported in a rigid and stable region of the first cheek and thus the limitation can be carried out safely.

According to example embodiments, the slope is formed such that in the region covered by the slope in the axial direction, the radial wall thickness of the first cheek increases monotonically, e.g., strictly monotonically, with decreasing distance from the second cheek. An advantage of this is that the axial end region of the first cheek is rigid and stable.

According to example embodiments, the slope has a conical shape, and the cone axis associated with the conical shape is oriented coaxially to the axis of rotation of the planet carrier. The advantage of this is that ready production is possible.

According to example embodiments, the region covered by the slope in the axial direction overlaps or adjoins the region covered in the axial direction by a shaft nut screwed onto an externally threaded section of the first cheek. An advantage of this is that the seating region for the shaft nut is stabilized and made rigid.

According to example embodiments, a first bearing is fitted onto the first cheek, and the region covered by the inner ring of the first bearing in the axial direction overlaps with the region covered by the slope in the axial direction. An advantage of this is that the region of the bearing seat of the bearing is made rigid via the slope.

According to example embodiments, the bearings of the input shaft and also the bearings of all other bearings are at a distance from the conical slope. For example, they do not rest against the conical slope with one of their inner rings or outer rings.

According to example embodiments, the securing ring is arranged in the axial direction between the slope and the second cheek. An advantage of this is that the securing ring is arranged in the rigid region of the first cheek.

According to example embodiments, the securing ring is received on a step of the first cheek. An advantage of this is that ready production is possible.

According to example embodiments, the shaft nut is set against the inner ring of the first bearing. An advantage of this is that the bearing tension can be readily adjusted.

According to example embodiments, the radial wall thickness of the first cheek is greater in the region covered by the securing ring in the axial direction than in the region covered by the externally threaded section and/or by the shaft nut in the axial direction. An advantage of this is that the securing ring is arranged in a more rigid region than the shaft nut.

According to example embodiments, a second bearing is fitted onto the second cheek, the inner ring of the second bearing is set against a step of the second cheek, and the outer ring of the second bearing and the outer ring of the first bearing are set against a projection having a ring gear toothing and protruding radially inwards on the housing part, e.g., are set in opposite directions to each other. An advantage of this is that the bearings can be arranged in an O arrangement.

According to example embodiments, the housing part is arranged as a ring gear, and an internal toothing is formed in the projection. For example, the internal toothing meshes with planet gears rotatably mounted on the bolts, e.g., via needle bearings, which are in mesh with a rotatably mounted sun gear. An advantage of this is that the number of parts is as small as possible and thus the production costs are low.

According to example embodiments, the planet carrier has such bores for receiving the planet wheel axes of the planets that the conical slope is, for example, completely interrupted in the circumferential direction by these bores, and, for example, is not only partially but even completely interrupted in the radial direction. An advantage of this is that the conical slope has interruptions in the circumferential direction and thus the elastic conditions are further optimized. The interruption caused by the respective bore is complete, i.e., complete in the radial direction. With regard to the elastic conditions, an optimum can thus be achieved.

The circumferential direction, radial direction and axial direction are always in relation to the axis of rotation of the planet carrier.

According to example embodiments, the first bearing is arranged as an angular contact bearing, and the second bearing is arranged as an angular contact bearing, e.g., in an O arrangement. An advantage of this is that high forces can be diverted.

According to example embodiments, the planetary gear unit has a first, e.g., input planetary gear stage, which has a planet carrier shaft that protrudes into the first cheek. The region covered by the planet carrier shaft in the axial direction includes the region covered by the slope in the axial direction. The first cheek is arranged at a distance from the planet carrier shaft. For example, within the region covered by the slope in the axial direction, the radial distance region covered by the planet carrier shaft is either at a radial distance from the radial distance region covered by the slope or includes the radial distance region covered by the slope.

An advantage of this is that in the variant with radial distance a larger oil volume and thus improved heat dissipation can be provided in the interior of the gear unit, which provides for a more powerful gear unit per installation volume. In the variant with radial overlap with the radial distance region covered by the slope, the planet carrier shaft can also be arranged at an angle in this region so that the planet carrier shaft can be made rigid. Since this is the output-side region of the planet carrier shaft, a large torque must be transmitted there with a small outer diameter of the planet carrier shaft, so that the planet carrier shaft, which is made rigid in this region, makes a significant contribution to the highest possible compactness.

Further features and aspects of example embodiments of the present invention are explained in more detail below with reference to the appended schematic Figures.

### BRIEF DESCRIPTION OF THE DRAWINGS

FIG. 1 is a cross-sectional view of a planetary gear unit with a planet carrier having a conical slope 3.

FIG. 2 is a perspective view of the planet carrier.

FIG. 3 is a top view of the planet carrier.

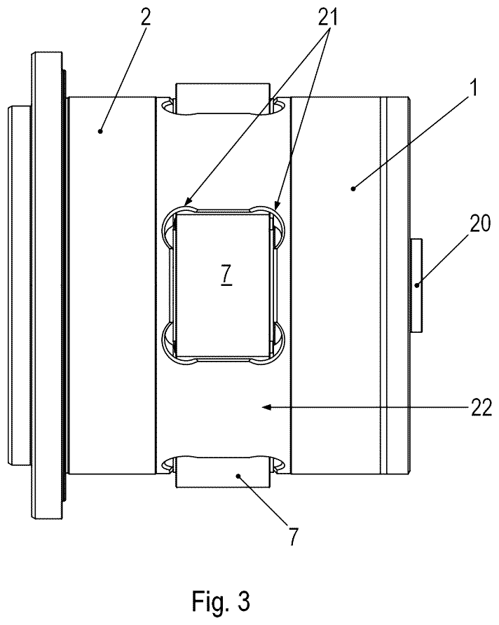

FIG. 4 is a top view of the bare planet carrier.

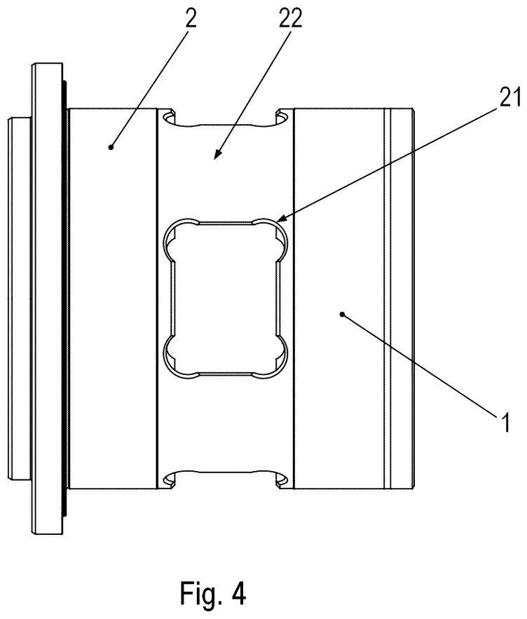

FIG. 5 is a perspective view of the bare planet carrier.

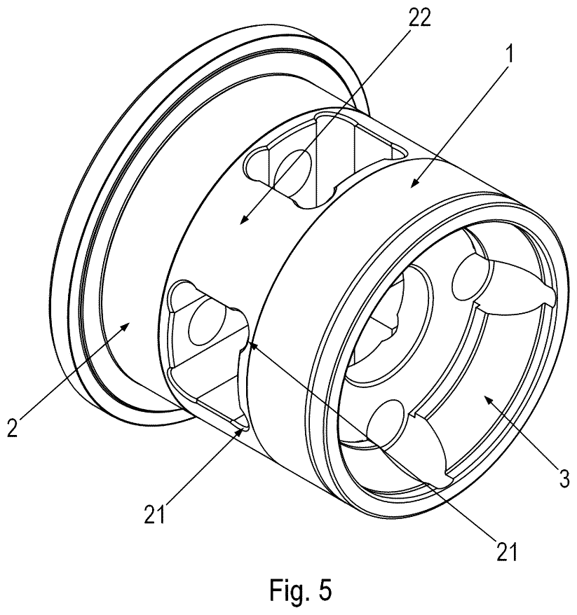

FIG. 6 is a perspective view of the gear stage of the planetary gear unit, which gear stage has the planet carrier.

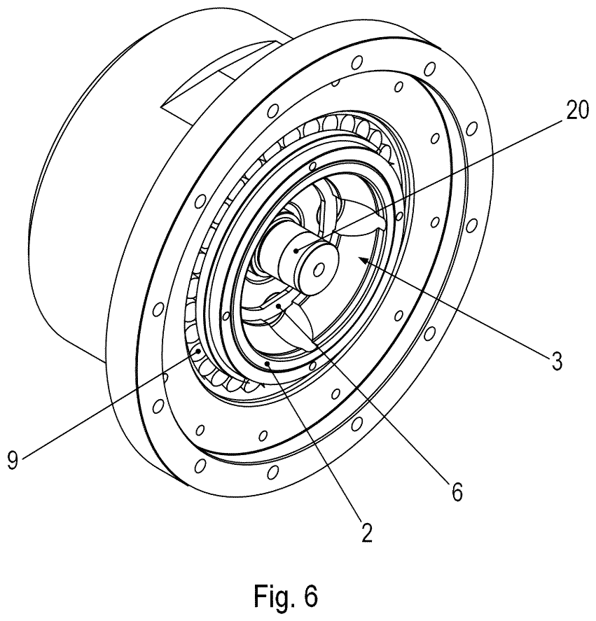

### DETAILED DESCRIPTION

As schematically illustrated in the Figures, the planetary gear unit has the planet carrier, which has a first cheek 1 and a second cheek 2, which are at a distance from each other in the axial direction and are connected via web regions 22 of the planet carrier. For example, the web regions 22 are at regular distances from each other in the circumferential direction.

In the circumferential direction between the web regions 22 nearest to each other, rectangular recesses are arranged, e.g., radially passing through the planet carrier, the corners of which recesses have fillets 21. Thus, the strength against lateral forces is increased. For example, the fillets 21 provide increased resistance to breakage.

In the planet carrier, planet gears 7 are mounted on bolts 8, e.g., via needle bearings, which are plugged into the first cheek 1 on the one hand and the second cheek 2 on the other.

The needle bearings are provided on the bolts and provide for a compact configuration.

The first cheek 1 of the planet carrier has a conical slope 3 on its inner surface, which conical slope 3 can be used to make the end region of the planet carrier rigid, which end region faces the input side of the gear unit.

The mathematically considered cone axis associated with the conical slope 3 is oriented coaxially to the axis of rotation of the planet carrier.

The planet carrier is made in one piece, e.g., in one part, from the first cheek 1, the second cheek 2, and the web regions 22.

The fillets 21 are arranged as simple bores before the respectively remaining recess is milled out during production.

On its radially outer circumference, the first cheek 1 has a bearing seat for a first bearing 4 of the planet carrier, which bearing 4 is received in a ring gear provided in a housing-forming manner. The internal toothing of the ring gear is at a distance from the bearing seat of the first bearing 4 in the axial direction.

On its radially outer circumference, the second cheek 2 has a bearing seat for a second bearing 9 of the planet carrier, which bearing 9 is received in the ring gear arranged in a housing-forming manner. The internal toothing of the ring gear is at a distance from the bearing seat of the second bearing 9 in the axial direction. The first bearing 6 is arranged at a distance from the second bearing 9 in the axial direction.

The planet gears 7 are arranged at a distance from each other in the circumferential direction, e.g., regularly, and in mesh with the internal toothing of the ring gear as well as in mesh with a sun gear, which is connected for conjoint rotation with the shaft 20 or is arranged in one part, e. g., in one piece, therewith.

A securing ring 6 is provided to axially limit the bolts 8, on which the planet gears 7 are rotatably mounted via needle bearings. This is because the bolts 8 are plugged into blind bores drilled in the second cheek 2 and protrude through bores passing through the first cheek 1, so that the end face of the bolts 8 protruding from the through bores respectively rests against the securing ring 6, which is received in an internal groove of the first cheek 1 and protrudes radially inwards from the first cheek 1.

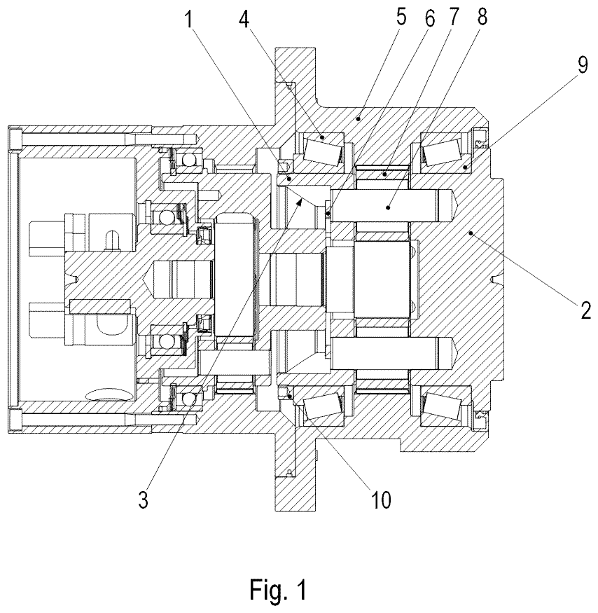

As illustrated in FIG. 1, the inner groove is arranged as a step on the inner surface of the first cheek 1. This provides for ready installation. This is because, driven by the elastic preload, the securing ring 6 can be radially expanded into the inner groove or, respectively, step through a central through-going opening in the first cheek after the bolts 8 have been inserted from the inner surface. However, the bolts 8 must be plugged sufficiently deep into the blind bores of the second cheek 2 in the axial direction.

The securing ring 6 is, for example, arranged at a distance from the conical slope 21 in the axial direction.

A step is formed on the radial outer circumference of the second cheek 2, against which the inner ring of the second bearing 2 is set.

The outer rings of the bearings 4 and 9 are set against a radially inwardly protruding projection of the ring gear, which projection carries the internal toothing.

An externally threaded region is formed on the radial outer circumference of the first cheek 1, onto which region a shaft nut is screwed, which rests against the inner ring of the first bearing 1. The bearing tension can thus be adjusted via the shaft nut. The bearing tension is fed back through the planet carrier, e.g., also through the region of the first cheek of the planet carrier that has the conical slope.

The toothing of the planet gears 7 protrudes into the respective recess.

In the region covered by the slope 3 in the axial direction, the outer circumference of the first cheek 1 is cylindrical on the outside, e.g., with a single, e.g., constant, radial distance.

The radial distance, the radial direction, the axial direction, and the circumferential direction are always in relation to the direction of the axis of rotation of the planet carrier.

According to example embodiments, a different shape of slope is used instead of the conical slope 3. In any case, however, with the planet carrier then used, in the region covered by the slope in the axial direction, the radial wall thickness of the first cheek 1 is a monotonically, e.g., strictly monotonically, increasing function of the distance with decreasing distance from the second cheek 2.

As illustrated in FIG. 1, a planet carrier shaft of an upstream input planetary gear stage protrudes into the first cheek of the planet carrier and is arranged at a distance, e.g., a radial distance, from the first cheek.

The planet carrier shaft is rotatably mounted with only one bearing in a housing part, because the sun gear plugged into the planet carrier shaft is quasi-mounted via the planet gears 7. Planets are rotatably mounted in the planet carrier shaft, which are in mesh with an input sun gear shaft and also with a ring gear toothing that is machined into the housing part.

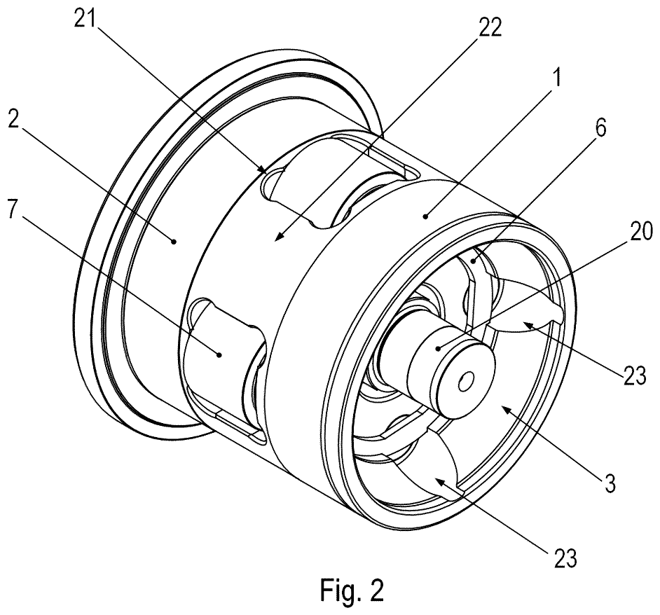

The planet wheel axes of the planets may be dimensioned so stably, e.g., with such a diameter, that the conical slope 3 is respectively not only partially but even completely interrupted in the radial direction, as illustrated in FIG. 2.

The shaft nut 10 is screwed with its internal thread onto the first cheek 1, which has an external thread for this purpose. It is also important here that the region covered by the shaft nut 10 in the axial direction overlaps with the region covered by the conical slope 3 in the axial direction. The elastic properties can thus be optimally provided.

A further advantage of the planetary gear unit is that the bearing of the input shaft and also all other bearings are at a distance from the conical slope 3, e.g., thus do not bear against the conical slope 3 with an inner ring or outer ring.

According to example embodiments, within the region covered by the slope in the axial direction, the radial distance region covered by the planet carrier shaft includes the radial distance region covered by the slope, e.g., the internal conical slope. Thus, the planet carrier shaft makes efficient use of the spatial region created by the slope and is thus provided with a correspondingly high wall thickness, so that the spreading of a heat flow can be improved and the rigidity is also increased, e.g., against transverse forces. For example, the planet carrier shaft itself has a corresponding slope, e.g., an external conical slope.

### LIST OF REFERENCE NUMERALS

1 First cheek
2 Second cheek
3 Conical slope
4 Bearing
5 Ring gear
6 Securing ring
7 Planetary gear
8 Bolt
9 Bearing
10 Shaft nut
20 Shaft
21 Fillet
22 Web region
23 Bore for planetary gear axle

1. to 15. (canceled)

16. A planetary gear unit, comprising:
a planet carrier including a first cheek, a second cheek, and web regions connecting the first cheek to the second cheek, the first cheek including an inner surface having a slope;
a ring gear; and
a securing ring received in the first cheek and arranged axially between the slope and the web regions.

17. The planetary gear unit according to claim 16, wherein bearings of the planet carrier and bearings of an input shaft of the planetary gear unit are arranged at a distance and/or at an axial distance from the slope.

18. The planetary gear unit according to claim 16, wherein bolts of the planetary gear unit are at least partially arranged in blind bores in the second cheek, and the bolts protrude through bores passing through the first cheek.

19. The planetary gear unit according to claim 16, wherein the securing ring axially limits a bolt of the planetary gear unit.

20. The planetary gear unit according to claim 16, wherein, in a region covered by the slope in an axial direction, a radial wall thickness of the first cheek increases monotonically or strictly monotonically with decreasing distance from the second cheek.

21. The planetary gear unit according to claim 16, wherein the slope has a conical shape, a cone axis associated with the conical shape being oriented coaxially to an axis of rotation of the planet carrier.

22. The planetary gear unit according to claim 16, wherein a shaft nut is screwed with an internal thread onto the first cheek having a mating external thread.

23. The planetary gear unit according to claim 16, wherein a region covered by the slope in an axial direction overlaps or adjoins a region covered in the axial direction by a shaft nut screwed onto an externally threaded section of the first cheek.

24. The planetary gear unit according to claim 16, wherein a first bearing is arranged on the first cheek, and a region covered by an inner ring of the first bearing in an axial direction overlaps with a region covered by the slope in the axial direction.

25. The planetary gear unit according to claim 16, wherein all bearings of the planetary gear unit are arranged at a distance from the slope.

26. The planetary gear unit according to claim 16, wherein the securing ring is arranged in an axial direction between the slope and the second cheek.

27. The planetary gear unit according to claim 16, wherein the securing ring is received on a step of the first cheek.

28. The planetary gear unit according to claim 22, wherein a region covered by the shaft nut in an axial direction overlaps with a region covered by the slope in the axial direction.

29. The planetary gear unit according to claim 22, wherein a first bearing is arranged on the first cheek, and a region covered by an inner ring of the first bearing in an axial direction overlaps with a region covered by the slope in the axial direction, and the shaft nut is set against an inner ring of the first bearing.

30. The planetary gear unit according to claim 22, wherein a radial wall thickness of the first cheek is greater in a region covered by the securing ring in an axial direction than in a region covered by the externally threaded section and/or by the shaft nut in the axial direction.

31. The planetary gear unit according to claim 24, wherein a second bearing is arranged on the second cheek, an inner ring of the second bearing being set against a step of the second cheek, an outer ring of the second bearing and an outer ring of the first bearing being set against a projection having a ring gear toothing and protruding radially inwardly on a housing part.

32. The planetary gear unit according to claim 31, wherein the housing part is arranged as a ring gear, and the projection includes an internal toothing.

33. The planetary gear unit according to claim 32, wherein the internal toothing meshes with planet gears rotatably mounted on bolts and being in mesh with a rotatably mounted sun gear.

34. The planetary gear unit according to claim 16, wherein the planet carrier includes bores receiving planet wheel axles of planets.

35. The planetary gear unit according to claim 31, wherein the first bearing and the second bearing are arranged as angular contact bearings.

36. The planetary gear unit according to claim 16, wherein the planetary gear unit includes a first planetary gear stage having a planet carrier shaft that protrudes into the first cheek, a region covered by the planet carrier shaft in an axial direction includes a region covered by the slope in the axial direction, the first cheek being arranged at a distance from the planet carrier shaft.

37. The planetary gear unit according to claim 36, wherein, within the region covered by the slope in the axial direction, a radial distance region covered by the planet carrier shaft is arranged at a radial distance from an radial distance region covered by the slope or includes the radial distance region covered by the slope.
